(19) United States
(12) Patent Application Publication
(10) Pub. No.: US 2025/0023276 A1
(43) Pub. Date: Jan. 16, 2025

(54) PLUG CONNECTOR, PLUG CONNECTOR MATING PIECE AND PLUG CONNECTOR SYSTEM

(71) Applicant: TE Connectivity Solutions GmbH, Schaffhausen (CH)

(72) Inventors: Harald ULRICH, Bensheim (DE); Stefan MASAK, Bensheim (DE); Kevin SCHEER, Bensheim (DE)

(21) Appl. No.: 18/768,735

(22) Filed: Jul. 10, 2024

(30) Foreign Application Priority Data
Jul. 14, 2023 (DE) 102023118722.8

(51) Int. Cl. H01R 13/187; H01R 13/04; H01R 13/11; H01R 13/629

(52) U.S. Cl. CPC H01R 13/187; H01R 13/04; H01R 13/11; H01R 13/629

(57) ABSTRACT

A plug connector is designed such that a plug connector mating piece can be plugged together with the plug connector along a connection direction. The plug connector has a contact socket, via which electrical contact with a correspondingly designed contact connector mating piece can be effected. The contact socket is formed in such a way that an electrical contact with the plug connector mating piece can be achieved via a contact pin and/or a mating contact socket of the plug connector mating piece.

### CROSS REFERENCE TO RELATED APPLICATIONS

This application claims the benefit of DE Application No. 102023118722.8, filed 14 Jul. 2023, the subject matter of which is herein incorporated by reference in its entirety.

### BACKGROUND OF THE INVENTION

The present invention relates to a plug connector, a plug connector mating piece and a plug connector system.

Plug connector systems are known from the prior art in many variants.

An object of the subject matter herein is to provide a plug connector. A further object of the subject matter herein is to provide a plug connector mating piece. A further object of the subject matter herein is to provide a plug connector system.

### BRIEF DESCRIPTION OF THE INVENTION

One or more objects of the subject matter herein are achieved by a plug connector, a plug connector mating piece and a plug connector system having the features of the independent claims. Various developments are specified in the dependent claims.

According to one aspect of the subject matter herein, a plug connector is provided which is designed such that a plug connector mating piece can be plugged together with the plug connector along a connection direction, wherein the plug connector comprises a connector housing, the connector housing defines an outer receiving region, the outer receiving region is configured in such a way that the plug connector mating piece can be inserted into the outer receiving region along the connection direction, a contact socket is arranged in the outer receiving region, the contact socket is sleeve-like and defines an inner receiving region, the inner receiving region is configured in such a way that, when the plug connector mating piece is inserted into the outer receiving region, a contact pin of the plug connector mating piece can be inserted into the inner receiving region, the outer receiving region is configured in such a way that, when the plug connector mating piece is inserted into the outer receiving region, a mating contact socket of the plug connector mating piece can be inserted into the outer receiving region, the sleeve-like contact socket has an inner lateral surface for making contact with the contact pin of the plug connector mating piece and an outer lateral surface for making contact with the mating contact socket of the plug connector mating piece, and an electrical contact between the plug connector and the inserted plug connector mating piece can be effected via the inner lateral surface and/or the outer lateral surface.

It is thereby possible to achieve the technical advantage that an improved plug connector can be provided. Here, the plug connector permits an electrical connection to an inserted plug connector mating piece via an electrical contact between the inner lateral surface and/or the outer lateral surface of the contact socket. Depending on the design of the respective plug connector mating piece, a contact can be achieved exclusively between the inner lateral surface of the contact socket, exclusively between the outer lateral surface of the contact socket or a contact between the inner lateral surface and the outer lateral surface of the contact socket. Because of the sleeve-like design of the contact socket, the inner lateral surface and the outer lateral surface provide contact-making surfaces of different sizes for the electrical contact with the plug connector mating piece. By virtue of the different contact-making surfaces, electrical connections can be provided for different current ranges. The larger the contact-making surface, the higher the currents that can be transmitted by the respective electrical connection.

Depending on the design of the plug connector mating pieces, electrical connections for different current ranges and voltage ranges can thus be provided by the plug connector.

According to the subject matter herein, a possible area of use of the plug connector is in vehicle construction and here, in particular, in a power supply of electrically operable vehicles. Here, the plug connector can be arranged on a vehicle battery. As a result of the wide applicability of the plug connector, which permits various electrical connections in different current ranges, a single model of the plug connector can be formed on the vehicle battery, which is configured to accommodate differently configured plug connector mating pieces and therefore to provide different electrical connections for different current ranges.

Only one plug connector model is therefore needed for the different electrical connections in different current and/or voltage ranges. The different types of connection are each effected via the appropriately configured plug connector mating pieces, which are each configured to make contact only with the inner lateral surface, only the outer lateral surface or the inner and outer lateral surface of the contact socket.

By means of the plug connector, it is thus possible to provide a plug connector which can be used for various plug connector mating pieces and which permits electrical connections for different current ranges. According to the subject matter herein, the plug connector is designed in particular for a high-current range.

According to one embodiment, a contact spring which is provided to produce the electrically conductive connection between the contact socket and the contact pin of the plug connector mating piece which is inserted into the receiving region is arranged on the lateral surface of the contact socket.

It is thereby possible to achieve the technical advantage that an optimized electrical contact between the inner lateral surface of the contact socket of the plug connector and the outer contact surface of the contact pin of the plug connector mating piece can be provided.

According to one embodiment, the contact spring is sleeve-like, arranged on the inner lateral surface and running around the latter.

It is thereby possible to achieve the technical advantage that an optimized electrical contact between the inner lateral surface of the contact socket of the plug connector and the outer contact surface of the contact pin of the plug connector mating piece can be provided. The sleeve-like contact spring can additionally improve the mechanical connection between the plug connector and the inserted plug connector mating piece, in that the contact pin of the plug connector mating piece is retained in the inner receiving region by the contact spring.

According to one embodiment, the contact spring is removably arranged on the inner lateral surface of the contact socket.

It is thereby possible to achieve the technical advantage that the plug connector can be used for various plug connector mating pieces. The contact-making area between the plug connector and the plug connector mating piece can be varied by removing or using the contact spring. Electrical connections, in particular in the high-current range, can hereby be implemented for different power classes.

According to one embodiment, the inner lateral surface and the outer lateral surface of the contact socket provide a contact-making area of 80 mm² for the electrical contact.

It is thereby possible to achieve the technical advantage that the plug connector can be used for various plug connector mating pieces. In particular, a use in the high-current range is made possible. The plug connector permits electrical connection to plug connector mating pieces having cables with cable cross sections between 15 mm² and 120 mm². In particular, by using the plug connector according to the subject matter herein and a correspondingly designed plug connector mating piece, an electrical high-current connection with rated currents up to 350 A and rated voltages up to 1200 V can be achieved.

According to one embodiment, the plug connector has a guide pin arranged in the inner receiving region, which is provided to be inserted into a receiving region of the contact pin of the plug connector mating piece, counter to the connection direction.

It is thereby possible to achieve the technical advantage that secured mating of the plug connector with a plug connector mating piece is made possible via the guide pin. Here, when the plug connector is plugged together with the plug connector mating piece, the guide pin is inserted into a receiving region of a contact pin of the plug connector mating piece. The receiving region extends along a longitudinal axis of the contact pin, so that as a result of introducing the guide pin, the plug connector mating piece is guided by the guide pin as it is inserted. This permits secured insertion and mating.

According to one embodiment, an electrically insulating finger guard is formed on the contact socket.

It is thereby possible to achieve the technical advantage that the safety of the plug connector can be ensured via the finger guard. Because of the area of use of the plug connector in the high-current range, the finger guard reduces the risk of injury to users of the plug connector system.

According to a further aspect, a plug connector mating piece is provided which is designed to be plugged together with a plug connector along a connection direction, wherein the plug connector mating piece comprises a contact pin, the contact pin is designed to be inserted along the connection direction into an inner receiving region defined by a contact socket of the plug connector, the contact pin defines an outer contact surface, and the making of an electrical contact between the plug connector and the plug connector mating piece can be effected via making an electrical contact between the outer contact surface of the contact pin and an inner lateral surface of the contact socket of the plug connector.

It is thereby possible to achieve the technical advantage that an improved plug connector mating piece which can be plugged together with the plug connector according to the subject matter herein can be provided, with the aforementioned technical advantages. The plug connector mating piece is suitable in particular for use in the high-current range and is configured to transmit rated currents up to 200 A, rated voltages up to 800 V.

According to one embodiment, the outer contact surface of the contact pin provides an electrical contact-making area of 45 mm² for the electrical contact, wherein the plug connector mating piece is designed for an electrical high-current connection to a cable having a cable cross section of 15 mm² to 35 mm².

It is thereby possible to achieve the technical advantage that a high-current connection can be provided. Via the 45 mm² contact-making area, by using the plug connector according to the subject matter herein, it is possible to achieve an electrical contact which is configured to transmit rated currents up to 200 A and rated voltages of up to 800 V.

According to a further aspect, a plug connector mating piece is provided which is designed to be plugged together with a plug connector along a connection direction, wherein the plug connector mating piece comprises a mating contact socket, the mating contact socket is sleeve-like and defines a receiving region, the receiving region is configured to receive a contact socket of the plug connector counter to the connection direction, the mating contact socket defines an inner contact surface, and an electrical contact between the plug connector and the plug connector mating piece can be effected via making an electrical contact between the inner contact surface of the mating contact socket of the plug connector mating piece and an outer lateral surface of the contact socket of the plug connector.

It is thereby possible to achieve the technical advantage that an improved plug connector mating piece which can be plugged together with the plug connector according to the subject matter herein can be provided, with the aforementioned technical advantages. The plug connector mating piece is suitable in particular for a use in the high-current range and is configured to transmit rated currents up to 250 A and rated voltages up to 1000 V. An enlarged contact-making area with respect to the contact pin can be provided by the mating contact socket. This permits a transmission of increased currents.

According to one embodiment, the plug connector mating piece also comprises a contact pin, wherein the contact pin is designed to be inserted along the connection direction into an inner receiving region defined by the contact socket of the plug connector, the contact pin defines an outer contact surface, and an electrical contact between the plug connector and the plug connector mating piece can be effected via making an electrical contact between the outer contact surface of the contact pin and an inner lateral surface of the contact socket and via making an electrical contact between the inner contact surface of the mating contact socket of the plug connector mating piece and the outer lateral surface of the contact socket of the plug connector.

It is thereby possible to achieve the technical advantage that an improved plug connector mating piece which can be plugged together with the plug connector according to the subject matter herein can be provided, with the aforementioned technical advantages. The plug connector mating piece is suitable in particular for use in the high-current range and is configured to transmit rated currents up to 320 A and rated voltages of up to 1200 V. Via the combination of the contact pin and the mating contact socket, as compared with the contact pin and the mating contact socket on their own, an enlarged contact-making area can be provided. This permits a transmission of once more increased currents.

According to one embodiment, the inner contact surface of the mating contact socket provides an electrical contact-making area of 95 mm² for the electrical contact, wherein the plug connector mating piece is designed for an electrical high-current connection to a cable with a cable cross section of 20 mm² to 50 mm².

It is thereby possible to achieve the technical advantage that a high-current connection can be provided. Via the 95 mm² contact-making area of the mating contact socket, in combination with the plug connector according to the subject matter herein, a contact for rated currents up to 250 A and rated voltages of up to 1000 V can be achieved.

According to one embodiment, the outer contact surface of the contact pin provides an electrical contact-making area of 45 mm² for the electrical contact, wherein the inner contact surface of the mating contact socket provides an electrical contact-making area of 95 mm² for the electrical contact, and wherein the plug connector mating piece is designed for an electrical high-current connection to a cable with a cable cross section of 50 mm² to 120 mm².

It is thereby possible to achieve the technical advantage that a high-current contact can be provided. By means of the combination of the contact-making area of 45 mm² of the contact pin and the contact-making area of 95 mm² of the mating contact socket, in combination with the plug connector according to the subject matter herein, an electrical contact for rated currents of up to 350 A and rated voltages of up to 1200 V can be provided.

According to one embodiment, a contact spring is formed on the inner contact surface of the mating contact socket, wherein the contact spring is configured to effect the electrical contact between the contact socket of the plug connector and the mating contact socket of the plug connector mating piece.

It is thereby possible to achieve the technical advantage that an improved electrical contact between the contact socket of the plug connector and the mating contact socket of the plug connector mating piece is made possible via the contact spring. The contact spring can additionally improve a mechanical retaining action of the plug connector in the plug connector mating piece, so that the plug connector mating piece is inserted into the plug connector so as to be secured.

According to one embodiment, the contact pin is sleeve-like and defines a receiving region, wherein the receiving region is configured to receive a guide pin of the plug connector counter to the connection direction.

In this way, it is possible to achieve the technical advantage that, as a result of receiving the guide pin in the receiving region of the contact pin, secured mating of the plug connector with the plug connector mating piece is made possible. Here, the receiving region extends along a longitudinal axis of the contact pin.

According to a further aspect, a plug connector system having a plug connector according to one of the preceding embodiments and a plug connector mating piece according to one of the preceding embodiments are provided.

It is thereby possible to achieve the technical advantage that an improved plug connector system having a plug connector according to the subject matter herein and a plug connector mating piece according to the subject matter herein with the above technical advantages can be provided.

### BRIEF DESCRIPTION OF THE DRAWINGS

The above-described properties, features and advantages of this invention will be explained in more detail below with reference to the appended figures. In the figures, in a respective schematic illustration:

FIGS. 1a and 1b show a plug connector system having a plug connector and a plug connector mating piece according to one embodiment in a connected state and a non-connected state;

FIGS. 2a and 2b show a plug connector system having a plug connector and a plug connector mating piece according to a further embodiment in a connected state and a non-connected state; and

FIGS. 3a and 3b show a plug connector system having a plug connector and a plug connector mating piece according to a further embodiment in a connected state and a non-connected state.

### DETAILED DESCRIPTION OF THE INVENTION

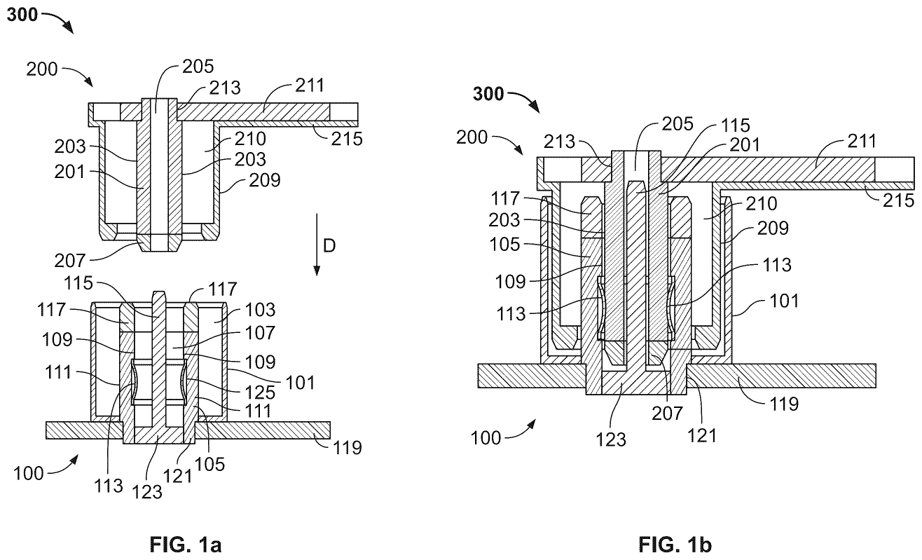

FIGS. 1a and 1b show a plug connector system 300 having a plug connector 100 and a plug connector mating piece 200 according to one embodiment in a connected state and a non-connected state.

In FIGS. 1 to 3, the plug connector system 300 is respectively illustrated in the non-connected and connected state in the graphics a) and b).

In the embodiment shown, the plug connector 100 has a connector housing 101. The connector housing 101 defines an outer receiving region 103, which is configured to receive a corresponding plug connector mating piece 200. To plug the plug connector 100 and the plug connector mating piece 200 together, the plug connector mating piece 200 is inserted into the plug connector 100 along the connection direction D, i.e. into the outer receiving region 103 of the connector housing 101.

The plug connector 100 additionally has a contact socket 105. The contact socket 105 is arranged centrally in the receiving space 103 of the connector housing 101. The contact socket 105 is designed to make electrical contact with the plug connector mating piece 200.

The contact socket 105 in the embodiment shown is sleeve-like and defines an inner receiving region 107 of the plug connector 100. A contact pin 201 of the plug connector mating piece 200 can be inserted into the inner receiving region 107. For this purpose, the contact pin 201 of the plug connector mating piece 200 is inserted into the inner receiving region 107 along the connection direction D.

The sleeve-like contact socket 105 has an inner lateral surface 109 and an outer lateral surface 111. The inner lateral surface 109 restricts the inner receiving region 107. The outer lateral surface 111 defines an inner boundary wall of the outer receiving region 103.

In the embodiment shown, the outer receiving region 103 is arranged around the contact socket 105 and is thus arranged to run annularly concentrically around the inner receiving region 107.

The contact socket 105 is formed from a metallic material. In various embodiments, contact of the plug connector 100 with the plug connector mating piece 200 can thus be effected via making electrical contact of the inner lateral surface 109 of the contact socket 105 and/or of the outer lateral surface 111 of the contact socket 105 with a corresponding contact-making element of the plug connector mating piece 200.

In the embodiment shown, a contact spring 113 is formed on the inner lateral surface 109 of the contact socket 105. The contact spring 113 is configured to effect or to improve electrical contact of the contact socket 105 with the contact pin 201 of the plug connector mating piece 200.

In the embodiment shown, the contact spring 113 is annular. The annular contact spring 113 is arranged on the inner lateral surface 109, running around the inner receiving region 107.

In the embodiment shown, the contact spring 113 is arranged in a recess 125 provided for the purpose in the inner lateral surface 109.

According to one embodiment, the contact spring 113 is removably arranged in the recess 125 in the inner lateral surface 109 of the contact socket.

As a result of the annular design, the contact spring 113 is capable of retaining, in the inner receiving region 107, the contact pin 201 of the plug connector mating piece 200 that is inserted into the inner receiving region 107 of the contact socket 105. For this purpose, as a result of the insertion of the contact pin 201 along the connection direction D into the inner receiving region 107, the contact pin is pushed through the annular contact spring 113.

The contact spring 113 additionally has an inwardly domed region 127. Via the domed region 127, the contact spring 113 is capable of exerting a contact pressure on the inserted contact pin 201 of the inserted plug connector mating piece 200. Thereby, the contact pin 201 of the plug connector mating piece 200 can be retained in the inner receiving region 107 of the contact socket 105.

As a result of the contact pressure of the contact spring 113 of the contact socket 105, an electrical contact between the inserted contact pin 201 and the contact socket 105 can also be improved.

In various embodiments, the contact spring 113 is made from a metallic material. The contact spring 113 can, for example, be made from a copper alloy.

In the embodiment shown, the plug connector 100 further comprises a guide pin 115. The guide pin is arranged centrally within the inner receiving region 107 of the contact socket 105. The guide pin 115 extends in a direction opposite to the connection direction D.

The guide pin 115 is used to guide the plug connector mating piece 200 as it is inserted into the plug connector 100. For this purpose, the guide pin 115 is configured to be inserted counter to the connection direction D into a pin receiving region 205 defined by the contact pin 201 as the contact pin 201 of the plug connector mating piece 200 is inserted into the inner receiving region 107 of the contact socket 105.

Via the insertion of the guide pin 115 into the pin receiving region 205 of the contact pin 201 of the plug connector mating piece 200, the mating of the plug connector 100 with the plug connector mating piece 200 can be improved, in that, by means of the guide pin 115, guidance of the plug connector mating piece 200 as it is inserted into the outer receiving region 103 of the connector housing 101 of the plug connector 100 is achieved.

In the embodiment shown, the guide pin 115 is connected to a guide base 123. In the embodiment shown, the guide base 123 forms a termination of the contact socket.

According to one embodiment, the guide pin 115 and/or the guide base 123 are made from an electrically insulating material. For example, the guide pin 115 and/or the guide base 123 are made from plastic. According to one embodiment, the guide pin 115 and the guide base 123 are made in one piece.

In the embodiment shown, the contact socket 105 has a finger guard 117. The finger guard 117 is formed on an end of the contact socket 105 that is arranged opposite to the guide base 123. The finger guard 117 is made from an electrically insulating material, for example plastic.

In the embodiment shown, the contact socket 105 has a contact-making section 121. Via the contact-making section 121, electrical contact between the contact socket 105 and a conductor element to which the plug connector 100 is electrically conductively connected is achieved.

In the embodiment shown, the conductor element is designed as a bus bar 119. According to one embodiment, the plug connector 100 can be connected to a vehicle battery of a vehicle, in particular an electrically operable vehicle.

In the embodiment shown, the contact-making section is integrated directly in the bus bar 119.

Here, the guide base 123 is formed between the annular contact-making section 121.

According to one embodiment, the connector housing 101 is made from an electrically insulating material, for example plastic.

The plug connector mating piece 200 in the embodiment shown has the already described contact pin 201 with the pin receiving region 205. The contact pin 201 has an outer contact surface 103. In the embodiment shown, the electrical contact between the plug connector 100 and the plug connector mating piece 200 inserted into the outer receiving region 103 of the plug connector 100 is made via an electrical contact between the outer contact surface 203 of the contact pin 201 and the inner lateral surface 109 of the contact socket 105 of the plug connector 100. In the embodiment shown, the contact can additionally or alternatively be effected via the contact spring 113.

The contact pin 201 is arranged centrally in a housing 209. The housing 209 defines a housing receiving region 210. As the plug connector mating piece 200 is inserted into the outer receiving region 103 of the connector housing 101 of the plug connector 100 along the connection direction D, the contact socket 105 of the plug connector 100 is received by the housing receiving region 210.

In the embodiment shown, the contact pin 201 is electrically connected to a cable 211 via a contact-making section 213. Hereby, an electrical connection between the plug connector mating piece 200 and the cable 211 is achieved.

In the embodiment shown, the contact pin 201 also has a finger guard made of an electrically insulating material, for example plastic.

In the embodiment shown, the housing 209 is likewise made from an electrically insulating material. In the embodiment shown, the housing 209 is connected to electrical insulation 215 of the cable 211. The connection of the housing 209 and the insulation 211 can in particular be made in one piece.

In the embodiment shown, the housing 209 is sleeve-like and, as the plug connector mating piece 200 is inserted into the plug connector 100, is received by the outer receiving region 103 of the connector housing 101.

According to one embodiment, the inner lateral surface 109 and the outer lateral surface 111 of the contact socket 105 of the plug connector 100 define a contact-making area of 80 mm² for making an electrical contact.

The outer contact surface 203 of the contact pin 201 of the plug connector mating piece 200 defines a contact-making area of 45 mm² for making the electrical contact. The plug connector mating piece 200 is designed here for a cable 211 having a cable cross section of 15-25 mm².

In the embodiment shown, the plug connector system 300 is thus designed for a high-current connection of rated currents of up to 200 A and rated voltages of up to 800 V.

In graphic b), the plug connector system 300 is shown in the connected state. The plug connector mating piece 200 has been inserted into the plug connector 100 along the connection direction D.

To mate the plug connector 100 and the plug connector mating piece 200 along the connection direction, the housing 209 of the plug connector mating piece 200 is received by the outer receiving region 103 of the connector housing 101 of the plug connector. Furthermore, the contact pin 201 of the plug connector mating piece 200 is received by the inner receiving region 107 of the contact socket 105. Analogously, the guide pin 115 of the plug connector 100 is received by the pin receiving region 205 of the contact pin 201 of the plug connector mating piece 200.

The contact spring 113, in particular the domed region of the contact spring 113, is compressed by the contact pin 201 inserted into the inner receiving region 107 of the contact socket 105. Hereby, the contact spring 113 is capable of exerting a contact pressure on the contact pin 201. Via the contact pressure, the electrical contact between the contact pin 201 and the contact socket 105 can be effected or improved. In addition, the contact pin 201 can be retained in the inner receiving region 107.

Besides the contact spring 113, the contact pin 201 contacts the inner lateral surface 109 of the contact sleeve 105 via its outer contact surface 203.

Via the contact shown, an electrical high-current connection with rated currents up to 200 A and related voltages up to 800 V is made possible.

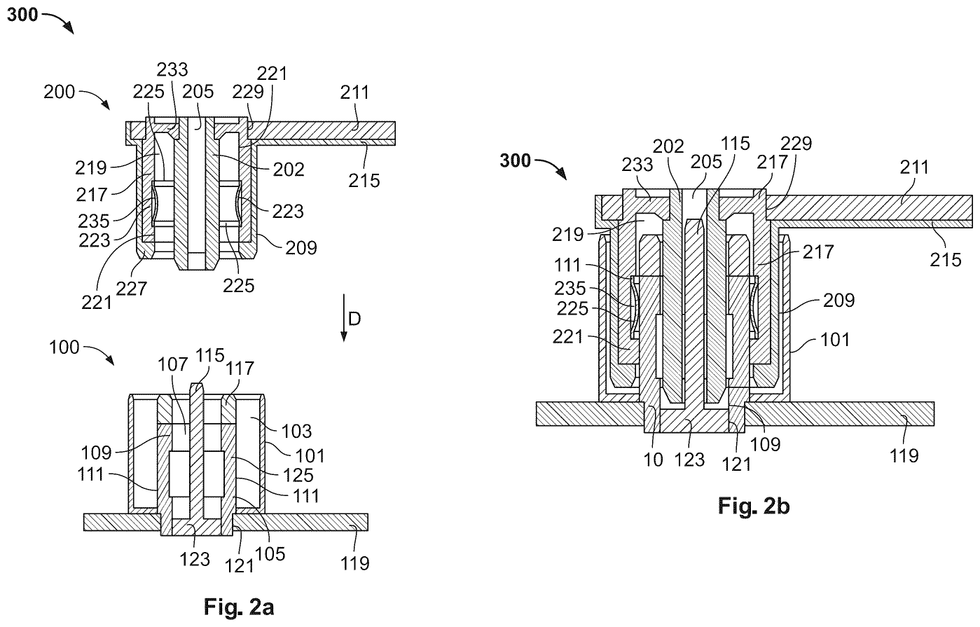

FIGS. 2a and 2b show a plug connector system 300 having a plug connector 100 and a plug connector mating piece 200 according to a further embodiment in a connected state and a non-connected state.

The embodiment shown is based on the embodiment in FIGS. 1a and 1b. As far as the configurations of the plug connector 100 and/or the plug connector mating piece 200 correspond to the configurations of the embodiment in FIGS. 1a and 1b, a renewed detailed description will be dispensed with.

In the embodiment shown, the plug connector 100 differs from the embodiment in FIGS. 1a and 1b only in the fact that the contact spring 113 has been removed.

In the embodiment shown, an electrical contact-making area of 80 mm² is still nevertheless provided by the inner lateral surface 109 and the outer lateral surface 111 of the contact socket 105.

In the embodiment shown, the plug connector mating piece 200 differs from the embodiment in FIGS. 1a and 1b primarily in the fact that the electrical contact of the plug connector mating piece 200 is effected not via the contact pin 201 but via a mating contact socket 217.

The mating contact socket 217 is sleeve-like and defines a socket receiving region 219. The mating contact socket 217 is arranged in the housing 209 in such a way that, when the plug connector mating piece 200 is connected to the plug connector 100, the contact socket 105 of the plug connector 100 is received by the socket receiving region 219.

The sleeve-like mating contact socket 217 has an inner lateral surface 221. The inner lateral surface 221 is used to make electrical contact with the outer contact surface 111 of the contact socket 105 of the plug connector 100 when the contact socket 105 is received in the socket receiving region 219 of the mating contact socket 217.

In the embodiment shown, the mating contact socket 217 further has a contact spring 225. The contact spring 215 is sleeve-like and, running onto the socket receiving region 219, is arranged on the inner contact surface 221 of the mating contact socket 219. For this purpose, the contact spring 225 is arranged in a recess 223 in the inner contact surface 221 of the mating contact socket 217. The recess 223 is formed in the inner contact surface 221, running appropriately annularly around.

The contact spring 215 has a domed region 233. As the contact socket 105 of the plug connector 100 is received in the socket receiving region 219, the domed region 233 is compressed by the contact socket 105. As a result, the contact spring is capable of exerting a contact pressure on the outer lateral surface 111 of the contact socket 105, whereby the electrical contact is improved and the contact socket 105 can be retained in the socket receiving region 219 of the mating contact socket 217.

In the embodiment shown, the contact pin 201 of the embodiment in FIGS. 1a and 1b is replaced by a mating guide pin 202. The mating guide pin 202 is not used to make electrical contact but, exclusively in interaction with the guide pin 115 of the plug connector 100, ensures the guidance of the connection and of the mating of the plug connector 100 and the plug connector mating piece 200.

For this purpose, in a manner analogous to the contact pin 201, the mating guide pin 202 has the pin receiving region 205, into which the guide pin 115 of the plug connector 100 can be inserted counter to the connection direction D as they are plugged together.

In the embodiment shown, the mating guide pin 202 is made from an electrically insulating material, for example plastic.

In the embodiment shown, the mating contact sleeve 217 is electrically conductively connected to the cable 211 via a contact-making region 229. Via the contact-making region 229, electrical contact of the plug connector mating piece 200 with the cable 211 is effected. The contact-making region 229 is formed in a base region 233 of the mating contact socket 217, which defines a termination of the mating contact socket 217.

In the embodiment shown, the mating contact socket 217 has a finger guard 227 formed at an end of the mating contact socket 217 arranged opposite to the contact-making region 229. The finger guard 227 is made from an electrically insulating material, for example plastic. In the embodiment shown, the finger guard 227 is integrally connected to the housing 209.

As the plug connector 100 is plugged together with the plug connector mating piece 200, the electrical contact between the plug connector 100 and the plug connector mating piece 200 is effected via the contact between the inner contact surface 221 of the mating contact socket 217 and the outer lateral surface 111 of the contact socket 105.

In the embodiment shown, an electrical contact-making area of 95 mm² is provided by the inner lateral surface 221 of the mating contact socket 217. The plug connector mating piece 200 can thus be used for cables 211 with a cable cross section of 25-50 mm².

The plug connector system 300 in the embodiment shown can thus be used for high-current connections with rated currents up to 250 A and rated voltages up to 1000 V.

In the connected state, as illustrated in graphic b), the housing 209 with the mating contact socket 217 is received in the outer receiving region 103. By contrast, the contact socket 105 is received in the socket receiving region 219. The outer lateral surface 111 of the contact socket 105 here contacts the inner contact surface 221 of the mating contact socket 217 and compresses the contact spring 225. The guide pin 115 is received in the pin receiving region 205 of the mating guide pin 202.

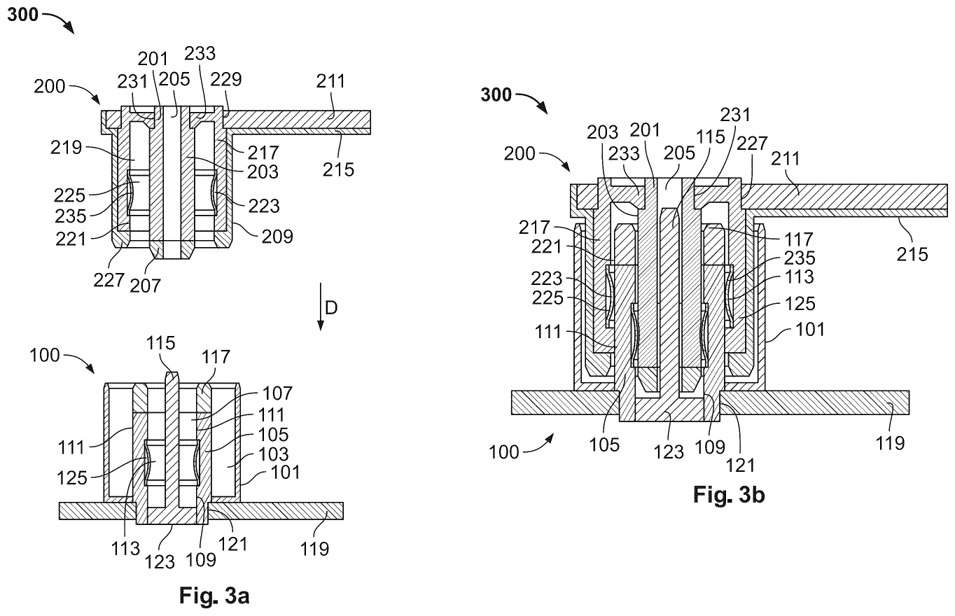

FIGS. 3a and 3b show a plug connector system 300 having a plug connector 100 and a plug connector mating piece 200 according to a further embodiment in a connected state and a non-connected state.

The embodiment shown is based on a combination of the embodiments of FIGS. 1a, 1b, 2a and 2b.

The plug connector 100 corresponds to the embodiment of FIGS. 1a and 1b and is unchanged relative to the latter.

The plug connector mating piece 200 has the contact pin 201 of the embodiment in FIGS. 1a and 1b and the mating contact socket 217 of the embodiment in FIGS. 2a and 2b.

In the embodiment shown, the contact pin 201 is connected to the bottom surface of the mating contact socket 217 via a contact-making region 231.

In the embodiment shown, the electrical contact is effected via the contact pin 201 and the mating contact socket 217. The contact pin 201 contacts the inner lateral surface 109 of the contact socket 105 via the outer contact surface 203, and the inner contact surface 221 of the mating contact socket 217 contacts the outer lateral surface 111 of the contact socket 105.

Via a combination of the outer contact surface 203 of the contact pin 201 and the inner contact surface 221 of the mating contact socket 217, an electrical contact-making area of 45 mm²+90 mm²=135 mm² can be effected. In this way, the plug connector mating piece 200 can be used for cables 211 with cable cross sections between 50 mm² and 120 mm².

In this way, by means of the plug connector system 200, a high-current connection with rated currents up to 320 A and rated voltages up to 1200 V can be provided.

The plug connector 100 according to the above-described embodiments can thus be used for plug connector mating pieces 200 according to the three embodiments described above. In this way, electrical high-current connections with rated currents between 200 and 320 A and rated voltages between 800 V and 1200 V can be effected via a plug connector 100. According to the embodiments described, the correspondingly described plug connector mating pieces 200 can be used for cables with cable cross sections between 15 mm² and 120 mm².

The plug connector system 300 permits a use in the automotive sector. In particular, a use in the electrical cabling of vehicle batteries, in particular of electrically operable vehicles, is possible. The plug connectors 100 suitable for the various cable cross sections and the various electrical connections with different rated currents and rated voltages can here in particular be installed or arranged directly on the battery. The different connections can be effected here via the different configurations of the plug connector mating pieces 200, as described above. The plug connector 100 as described above is thus suitable for effecting the different electrical high-current connections as described above.

In the above embodiments, the connector housing 101, the contact socket 105 and the contact pin 201 are designed with a cylindrical form. The plug connector system 300 is thus suitable for round contact designs. However, the connector housing 101, the contact socket 105 and the contact pin 201 can alternatively also be formed with angular cross sections. In this embodiment, the plug connector system 300 is suitable for flat contact designs.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A plug connector for mating with a plug connector mating piece along a connection direction, the plug connector comprising:
a connector housing defining an outer receiving region configured to receive the plug connector mating piece along the connection direction, the outer receiving region configured in such a way that, when the plug connector mating piece is inserted into the outer receiving region, a mating contact socket of the plug connector mating piece can be inserted into the outer receiving region;
a contact socket arranged in the outer receiving region, the contact socket being sleeve-like and defining an inner receiving region, the inner receiving region is configured in such a way that, when the plug connector mating piece is inserted into the outer receiving region, a contact pin of the plug connector mating piece can be inserted into the inner receiving region, the sleeve-like contact socket having an inner lateral surface for making contact with the contact pin of the plug connector mating piece, the sleeve-like contact socket having an outer lateral surface for making contact with the mating contact socket of the plug connector mating piece; and
wherein electrical contact between the plug connector and the inserted plug connector mating piece is effected via at least one of the inner lateral surface and the outer lateral surface.

2. The plug connector as claimed in claim 1, further comprising a contact spring arranged on the inner lateral surface of the contact socket, the contact spring configured to form an electrically conductive connection between the contact socket and the contact pin of the plug connector mating piece that is inserted into the inner receiving region.

3. The plug connector as claimed in claim 2, wherein the contact spring is sleeve-like and, running around the inner lateral surface, is arranged on the inner lateral surface of the contact sleeve.

4. The pl plug connector as claimed in claim 2, wherein the contact spring is removably arranged on the inner lateral surface of the contact socket.

5. The plug connector as claimed in claim 1, wherein the inner lateral surface and the outer lateral surface of the contact socket provide a contact-making area of 80 mm² for the electrical contact.

6. The plug connector as claimed in claim 1, further comprising a guide pin arranged in the inner receiving region, the guide pin is configured to be inserted into a pin receiving region of the contact pin of the plug connector mating piece counter to the connection direction.

7. The plug connector as claimed in claim 1, further comprising an electrically insulating finger guard on the contact socket.

8. A plug connector mating piece for plugging together with a plug connector along a connection direction, the plug connector mating piece comprising:
a contact pin configured to be inserted along the connection direction into an inner receiving region defined by a contact socket of the plug connector, the contact pin including an outer contact surface configured to make an electrical contact with an inner lateral surface of the contact socket of the plug connector to electrically connect the plug connector mating piece and the plug connector.

9. The plug connector mating piece as claimed in claim 8, wherein the outer contact surface of the contact pin provides an electrical contact-making area of 45 mm² for the electrical contact, and wherein the plug connector mating piece is designed for an electrical high-current connection to a cable with a cable cross section of 15 mm² to 35 mm².

10. A plug connector mating piece for plugging together with a plug connector along a connection direction, the plug connector mating piece comprising:
a mating contact socket, the mating contact socket being sleeve-like and defines a socket receiving region, the socket receiving region is configured to receive a contact socket of the plug connector counter to the connection direction, the mating contact socket defines an inner contact surface;
wherein electrical contact between the plug connector mating piece and the plug connector is configured to be effected via making an electrical contact between the inner contact surface of the mating contact socket of the plug connector mating piece and an outer lateral surface of the contact socket of the plug connector.

11. The plug connector mating piece as claimed in claim 10, further comprising a contact pin configured to be inserted along the connection direction into an inner receiving region defined by the contact socket of the plug connector, the contact pin defines an outer contact surface, wherein electrical contact between the plug connector mating piece and the plug connector is configured to be effected via making an electrical contact between the outer contact surface of the contact pin and an inner lateral surface of the contact socket and via making an electrical contact between the inner contact surface of the mating contact socket of the plug connector mating piece and the outer lateral surface of the contact socket of the plug connector.

12. The plug connector mating piece as claimed in claim 10, wherein the inner contact surface of the mating contact socket provides an electrical contact-making area of 95 mm² for the electrical contact, and wherein the plug connector mating piece is designed for an electrical high-current connection to a cable with a cable cross section of 20 mm² to 50 mm².

13. The plug connector mating piece as claimed in claim 11, wherein the outer contact surface of the contact pin provides an electrical contact-making area of 45 mm² for the electrical contact, wherein the inner contact surface of the mating contact socket provides an electrical contact-making area of 95 mm² for the electrical contact, and wherein the plug connector mating piece is designed for an electrical high-current connection to a cable with a cable cross section of 50 mm² to 120 mm².

14. The plug connector mating piece as claimed in claim 11, wherein the contact pin is sleeve-like and defines a pin receiving region, and wherein the pin receiving region is configured to receive a guide pin of the plug connector counter to the connection direction.

15. The plug connector mating piece as claimed in claim 10, wherein a contact spring is formed on the inner contact surface of the mating contact socket, and wherein the contact spring is configured to effect the electrical contact between the contact socket of the plug connector and the mating contact socket of the plug connector mating piece.

16. A plug connector system comprising:
a plug connector including a connector housing defining an outer receiving region and a contact socket arranged in the outer receiving region, the contact socket being sleeve-like and defining an inner receiving region; and
a plug connector mating piece including a mating contact socket defining an inner contact surface and a contact pin defining an outer contact surface, the mating contact socket being sleeve-like and defines a socket receiving region receiving the contact socket of the plug connector counter to the connection direction, the contact pin inserted into the inner receiving region of the contact socket of the plug connector along the connection direction, the contact pin.

17. The plug connector system as claimed in claim 16, wherein the outer receiving region is configured in such a way that, when the plug connector mating piece is inserted into the outer receiving region, a mating contact socket of the plug connector mating piece can be inserted into the outer receiving region.

18. The plug connector system as claimed in claim 16, wherein the inner receiving region is configured in such a way that, when the plug connector mating piece is inserted into the outer receiving region, the contact pin of the plug connector mating piece can be inserted into the inner receiving region, the sleeve-like contact socket having an inner lateral surface for making contact with the contact pin of the plug connector mating piece, the sleeve-like contact socket having an outer lateral surface for making contact with the mating contact socket of the plug connector mating piece, wherein electrical contact between the plug connector and the inserted plug connector mating piece is effected via at least one of the inner lateral surface and the outer lateral surface.

19. The plug connector system as claimed in claim 16, wherein electrical contact between the plug connector mating piece and the plug connector is configured to be effected via making an electrical contact between the inner contact surface of the mating contact socket of the plug connector mating piece and an outer lateral surface of the contact socket of the plug connector.

20. The plug connector system as claimed in claim 16, wherein electrical contact between the plug connector mating piece and the plug connector is configured to be effected via making an electrical contact between the outer contact surface of the contact pin and an inner lateral surface of the contact socket and via making an electrical contact between the inner contact surface of the mating contact socket of the plug connector mating piece and an outer lateral surface of the contact socket of the plug connector.
